(19) United States
(12) Patent Application Publication
(10) Pub. No.: US 2011/0251962 A1
(43) Pub. Date: Oct. 13, 2011

(54) Transaction method for secure electronic gift cards

(76) Inventor: John Hruska, Stuart, FL (US)

(21) Appl. No.: 13/086,052

(22) Filed: Apr. 13, 2011

Related U.S. Application Data
(60) Provisional application No. 61/323,593, filed on Apr. 13, 2010.

(51) Int. Cl. G06Q 40/00; G06Q 20/00; H04L 9/32

(52) U.S. Cl. 705/72; 705/39

(57) ABSTRACT

Disclosed is a novel method of sending electronic gift cards. The cards enable people when they are in a hurry and they want to do last minute shopping for special occasions, the holidays, including those special events such as anniversaries, birthdays and special event days. The invention allows anyone with a mobile device to send a personalize “gift card” to anyone else who also has a mobile device anywhere. Through secure personal accounts, the consumer may tell the transaction server, about whom to send the gift to, how much, and select the occasion or customized message. The electronic “gift card” can be in one of the alternative forms, such as just text, image, or video message. The delivery of the “gift card” can be scheduled instantly or anytime in the future. It can also be periodic. The delivery of the card is secured and guaranteed as is the redemption and transaction process. The innovation also allows setup of recurring delivery of gifts as well as reminder alerts of upcoming special events or occasions.

### PRIORITY CLAIM

This application claims priority of U.S. Provisional Patent Application No. 61/323,593, filed on Apr. 13, 2010, the contents of which are incorporated herein by reference.

### FIELD OF INVENTION

The field of the present invention relates in general to the web and secure mobile-based financial transactions and mobile gifting program.

### COPYRIGHT AUTHORIZATION

A portion of the disclosure of this patent document contains material that is subject to copyright protection. The copyright owner has no objection to the facsimile reproduction by any one of the patent disclosures, as it appears in the U.S. Patent and Trademark Office patent files or records, but otherwise reserves all copyrights whatsoever.

### BACKGROUND OF THE INVENTION

Web is simplifying our lives and has significantly enhanced our productivity. We can not only find many of our necessities on the Internet but also can manage our finances and pay for the services on the Internet. The forces that are playing a role in its emergence include the broadband always-on connections that are rapidly becoming mainstream and ubiquitous. It makes it possible to conduct even small tasks on tasks through the web as it is readily available. The number of people that go online for a variety of tasks related to their personal lives and for their jobs is increasing every minute. However, many of these tasks including the financial transactions still consume significant time. Ensuing this web revolution, the revolution based on mobile computing will happen. Mobile devices have most of the features that desktop computers have, but they have the addition advantage that they are always close by to the user; they are generally considered more secure. Akin to web transactions, this patent addresses the area of secure cellular transactions. Even though web based transactions have made our lives simpler, they are still considered relatively unsafe, they are time consuming, unsafe to a certain degree and cumbersome to say the least. Because cell phones have evolved from an industry, in which security was considered important from the very beginning, unlike the computers, transactions based on cellular identity of a user are inherently more secure. They are also versatile because we tend to carry our phones with us all the time. This innovation describes a secure method of doing transactions that was not possible before.

This innovation proposes a novel method for 1) sending and receiving an electronic mobile gift card to a mobile digital device, 2) establishing a secure private, protected proxy gifting account for said mobile digital devices as a protective buffer layer for all other fixed-number financial accounts, 3) a unique mobile device registration process to said mobile proxy gifting account, 4) secure activation of funds and, 5) secure utilization and spending of these funds, with said registered mobile digital device, which reside in said gifting proxy account. This unique gifting service will provide environmentally conscious and time-pressured people the convenience to create their own personalized gifts cards from their own mobile digital device or from a gifting web site for any reason including various holidays such as: anniversaries, birthdays, special event days, etc. Anyone with a mobile device is able to send a personalize “gift card” to anyone's mobile device anywhere they are located. The recipient of such a gift, once their mobile device has been registered for the first time, can use these gift(s) at any on-line retailer, online-Ad, online Auction, printed Ad, any Ad, restaurants, service provider and/or brick and mortar establishments associated with this program. Through their secure personal accounts, a request to the transaction server: which mobile device to send the gift to, who to send the gift to, the amount of the gift, the selected the occasion and a customized message. The electronic “gift card” can be in one of the alternative forms, such as just text, image, or video message. The delivery of the “gift card” can be scheduled instantly or anytime in the future. It can also be recurrent and periodic. The delivery of the card is secured and guaranteed as is the redemption and transaction process. The innovation also allows setup of recurring delivery of gifts as well as reminder alerts of upcoming special events or occasions.

Current web based transactions are usually conducted using browsers with web servers that have been secured using SSL or TLS protocols. While shopping, the user typically adds items in an electronic shopping cart, and when they are ready to buy the selected items, they are taken to a billing page where they have to, inconveniently, enter their billing address, full name, credit card number and other credentials that are used to establish identity of the user, and decrease the possibility of a fraud.

The problem with this method of transactions is that for every transaction, the user has to re-enter their personal identifying information. This creates problems at several levels. Vital information gets exposed to and stored on several systems while the transaction is being conducted. It is really designed from the prospective securing the interests of the vendor. However, it puts the privacy and financial records of the user at risk. Once the information gets into malicious hands, it is very difficult for the victim to recover, as her financial credit is tied up with her personal information.

The current system of transactions has these problems because it is not suitable for the new paradigm it is easier to store and process information more than we could have ever imagined along with broadband always-on connections that are rapidly becoming mainstream and ubiquitous. Because it is so easy, the personal information even in a single transaction gets stored in many different computers that are not always under the control of a single authority. Any break-in into these systems can expose the identities and the financial account credentials of a millions of people at risk all at once.

There is a need for a transactional model, in which the entire identity of a user is not required or hidden for a financial transaction. This innovation effectively uses the mobile phone as the basis of such financial transactions, that are easy to conduct, and do not require users to repeatedly expose their personal information every time a transaction is conducted.

The need for the electronic gifting arises because we see the regular gift cards are very popular, but at the same time are cumbersome to obtain, store and use. However, it is often seen users forgetting them, losing them, or just not having them on person, when they are really needed. They are also limited to use at a single vendor. Furthermore, buying and sending them to remote users is not always easy, is time consuming and non-economical. The buyer has to go to a store, or order them online. In both cases delivery to the recipients takes significant amount of time in some cases days and is inconvenient. Hence, there is a need, for a new paradigm of electronic gift cards that can be securely and instantaneously delivered to the recipient, cannot get lost because they are stored in the recipient's personal account that can only be accessed by their registered mobile digital device or personal electronic device. In addition, the usage is extremely flexible.

### SUMMARY OF THE INVENTION

The owner of the mobile device 3000 uses a web browser on their computer 1000 to access the secure web server 12000 to establish a personal account with the system. At this the user will have to provide detailed information including their cell phone number, including password, address, personal identification number (PIN), credit card or any other form of financial account information and registers their mobile digital device so that the system can authenticate and establish the true identity and credit of the user. This is a one-time sign up process, which does not have to be repeated, unless there is a problem. Once the owner's identity has been authenticated and established, a mobile specific application is sent to, downloaded and stored on the user's registered mobile device. The mobile application allows the registered user to securely send gift cards and also generate fund specific code IDs against the funds residing in their personal gifting proxy account. The user calls the mobile device application and enters their PIN# to decrypt their private key, if correct the application securely logs into, over TLS/SSL protocol, the secure server using the electronic device they registered to their account, the device and the application is identified to verify and activate their secure gifting proxy account. Once this account is activated the secure web server 1200 request the secure transaction server 13000 to send the user a single-use, user and device specific-pseudorandom transaction code in one of the several alternative forms to their registered mobile device 3000 identified by the cell phone number.

The owner can then use this single-use, user and device specific-pseudorandom transaction code for conducting a financial transaction or any other secure transaction. This is achieved by one of several processes: scanning a picture representation of transaction code, transferring data through various established and non-established electronic-spectrum modalities or manually inputting the single-use, user and device specific-pseudorandom transaction code together along with the mobile device phone number into the online merchant's gifting payment processing website or computer 2000, either manually by the user himself, by the merchant or by scanning the depiction/barcode from the owner's mobile device's screen 3000 by a scanning device attached to or communicating with the merchant computer 2000.

Once the transaction has been completed a new single-use transaction code is sent to the mobile device of the owner, when the owner request this or can be automatically generated and sent if user wants.

Please note that the mobile device owner's computer running the web browser 1000 can in fact be built into the Mobile Device 3000 as most future mobile devices are expected to have browsing capability.

Alternately, note that the entire user and device-specific, single-use, time sensitive, transaction code can be generated and carried out on the registered digital mobile device.

This innovation proposes a novel method for 1) sending and receiving an electronic mobile gift card to a mobile digital device, 2) establishing a secure private, protected proxy gifting account for said mobile digital devices as a protective buffer layer for all other fixed-number financial accounts, 3) a unique mobile device registration process to said mobile proxy gifting account, 4) secure activation of funds, and 5) secure utilization and spending of these funds, with said registered mobile digital device, which reside in said gifting proxy account. This unique gifting service will provide environmentally conscious and time-pressured people the convenience to create their own personalized gifts cards from their own mobile digital device or from a gifting web site for any reason including various holidays such as: anniversaries, birthdays, special event days, etc. Anyone with a mobile device is able to send a personalize “gift card” to anyone's mobile device anywhere they are located. The recipient of such a gift, once their mobile device has been registered for the first time, can use these gift(s) at any on-line retailer, online-Ad, online Auction, printed Ad, any Ad, restaurants, service provider and/or brick and mortar establishments associated with this program. Through their secure personal accounts, a request to the transaction server: which mobile device to send the gift to, who to send the gift to, the amount of the gift, the selected the occasion and a customized message. The electronic “gift card” can be in one of the alternative forms, such as just text, image, or video message. The delivery of the “gift card” can be scheduled instantly or anytime in the future. It can also be recurrent and periodic. The delivery of the card is secured and guaranteed as is the redemption and transaction process. The innovation also allows setup of recurring delivery of gifts as well as reminder alerts of upcoming special events or occasions.

This innovation also proposed a novel method sending and receiving electronic gift cards by the owners of the mobile device 1000. These mobile electronic gift cards will enable people to purchase a gift to for their recipients when they are in a hurry and they want to do last minute shopping for special occasions, the holidays, including those special events such as anniversaries, birthdays and special event days. This part of the invention creates allows anyone with a mobile device to send a personalized “electronic gift card” to anyone else who also has a mobile device anywhere. The recipient of such a gift can use it at any of the on-line retailers/restaurants or their brick and mortar establishments associated with this program. Through their secure personal accounts, they direct the transaction server, about whom to send the gift to (recipient), how much, and select the occasion and customized message along with picture or video sent to phone using SMS/MMS. The mobile-electronic gift card can be in one of the alternative forms, such as just text, image, or video message. The delivery of the “gift card” can be scheduled instantly or anytime in the future. It can also be periodic. The delivery of the card is secure and guaranteed. The innovation also allows setup of recurring delivery of gifts as well as reminder alerts of upcoming special events to the mobile device.

An objective of the invention is to teach a method of transaction authentication that is based on always available mobile device is proposed, and the method comprising the steps of:
Setting up and linking a unique mobile communication device, identified by said device's identifications number (cell phone #, EIN#, or other) to a secure account to perform secure transactions
Establishing a PIN # specifically for the mobile communication device's identification number and the secure proxy account that the device is linked/associated in order to perform secure transactions
Mobile communication device identity verified and linked to this secure account in secure server by PIN# and private/public key encryption through secure tls/ssl communication channel.
Mobile communication device, on behalf of and initiated by the owner of the secure account, the owner by using mobile specific application calls into the secure server using registered mobile communication device and accessing secure account and secure server confirming registered mobile device, request a unique, user and device specific pseudorandom, single-use, time-sensitive transaction code to be generated.
Secure server generating a unique, user and device specific single-use, time sensitive, pseudorandom number transaction code by the transaction server,
Sending the unique user and device-specific, single-use, time-sensitive pseudorandom generated transaction code number, digital depiction or other type of picture to mobile device through electronics means instantly using the communication network
Using this unique number/digital depiction in association with or combination with the mobile device ID # as the means of verification for guaranteeing of payment to the merchant from secure account
Using the user and device-specific, time-sensitive, single-use pseudorandom generated transaction code within the time period of activation allotted
Using the user and device-specific, time-sensitive single-use pseudorandom generated transaction code for just one transaction, and after it is used once, a new unique user and device-specific, single-use and time-sensitive pseudorandom transaction code is requested, generated and sent to the registered mobile communication device.
mobile device that has been activated through a web base process or other application process using a PIN# created and assigned by user to that mobile device # (cell phone #).

Another objective of the invention is to disclose the use of the SMS protocol of the cell phones to send the unique random code to the mobile device.

Another objective of the invention is to disclose the use of the MMS protocol of the cell phones to send the unique random code to the mobile device using a bar code image that is then scanned by the merchant for easy data entry.

Another objective of the invention is wherein MMS protocol of the cell phones is used to send the unique random code to the mobile device using a 2-dimensional bar code image that is then scanned by the merchant for easy data entry.

Another objective of the invention is wherein MMS protocol of the cell phones is used to send the unique random code to the mobile device using a video image that is time-sensitive and inactive after an allotted amount of time.

Another objective of the invention is wherein any protocol available on the cell phones or mobile digital devices is used to send the unique user and device-specific pseudorandom transaction code to the mobile device.

Another objective of the invention is wherein any protocol of the available on cell phones is used to send the unique, user and device specific, single use pseudorandom transaction code to the mobile device using an encrypted bar code, or any other type of image that can be decrypted by the mobile application residing on the registered mobile device and transferring data to merchant's POS/computer/registered mobile device using various electronic spectrum modalities.

Another objective of the invention is to disclose the use of a method of user registration and user's personal mobile digital device registration, whereas all data related to user's identity is collected from the user and is used for back-end transactions.

Another objective of the invention is to disclose the use of a method of recovering when one of the transaction codes generated and send using the method of 1 is lost, by allowing owners of the mobile device to obtain another transaction code.

Another objective of the invention is to disclose the use of a method of sending a monetary gift to a mobile communication device.

Another objective of the invention is to disclose the use of the a method of securely processing the monetary gifts using the mobile communication device registered to the secure financial (or other) proxy account for secure purchase transactions at internet based or free standing retailers.

Another objective of the invention is to disclose the use of a method of sending a monetary gift by a sender to a recipient for special occasions to recipient's mobile communication device and account of recipients for which that mobile communication device is registered to said account.

Another objective of the invention is to disclose the use of a method wherein a sender of a monetary gift prompts the recipient of said gift to establish a secure financial proxy mobile device account in order to receive a monetary gift and perform transactions from this proxy account.

Another objective of the invention is to disclose the use of a method for merchants to accept the unique transaction code of the secure mobile communication account and to receive payment for purchases from gift funds through the use of the merchants POS/computer or registered mobile device application or online payment processor.

Another objective of the invention is to disclose the use of a method of recipient of monetary gift being able to forward or share gift with another mobile communication device associated or not associated with secure account.

These and other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DIAGRAMS

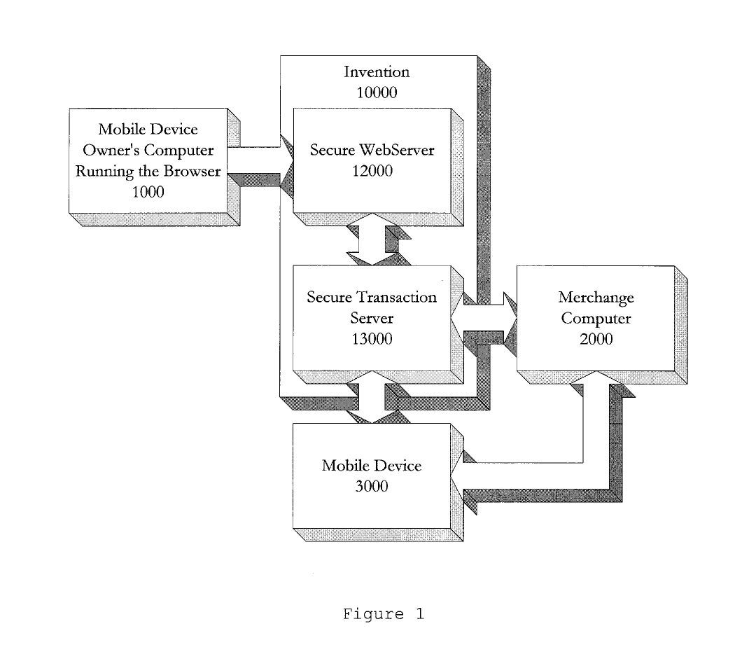

FIG. 1 Block Diagram of Main Components.

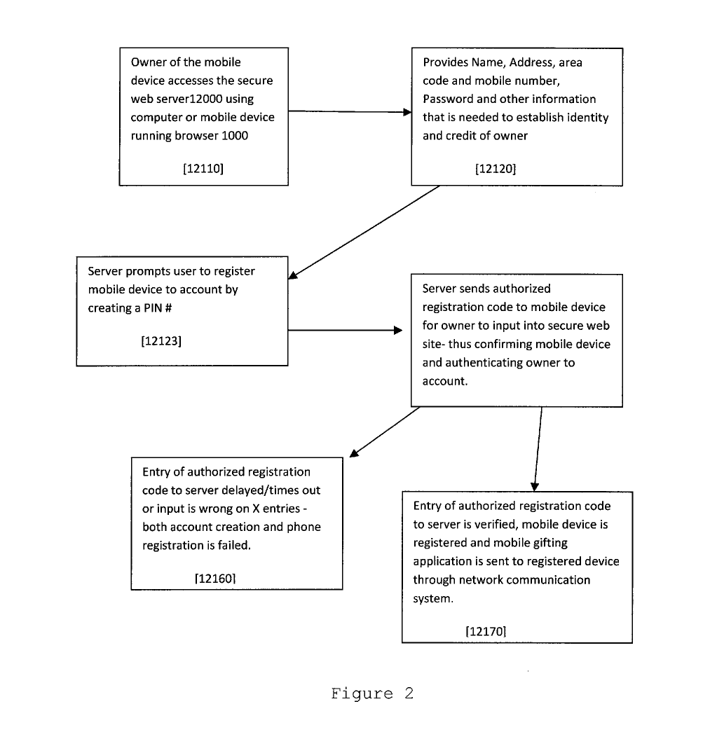

FIG. 2 is a diagram of the Process for Creating a New Account.

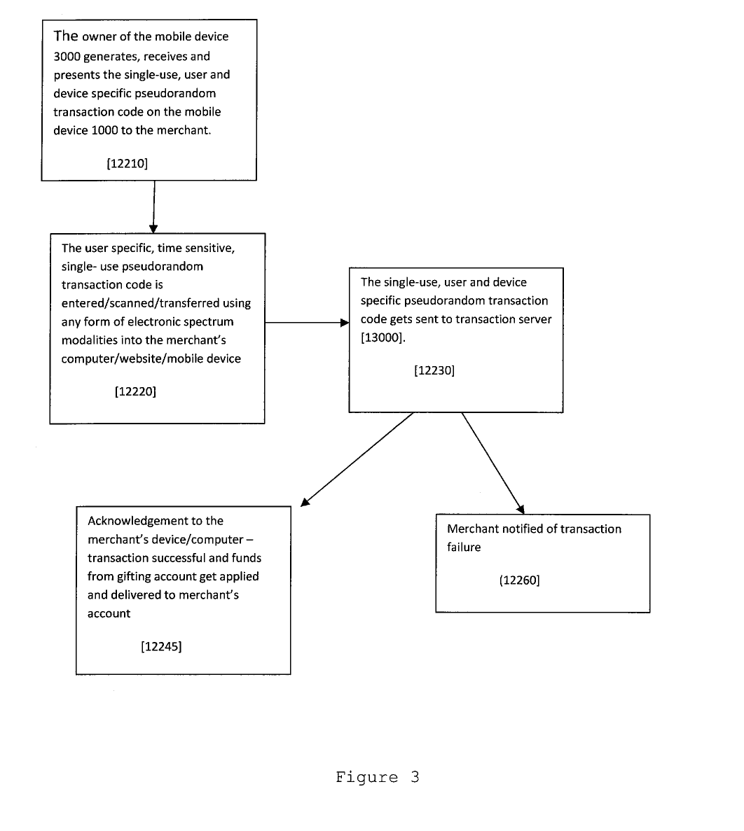

FIG. 3 is diagram of a transaction.

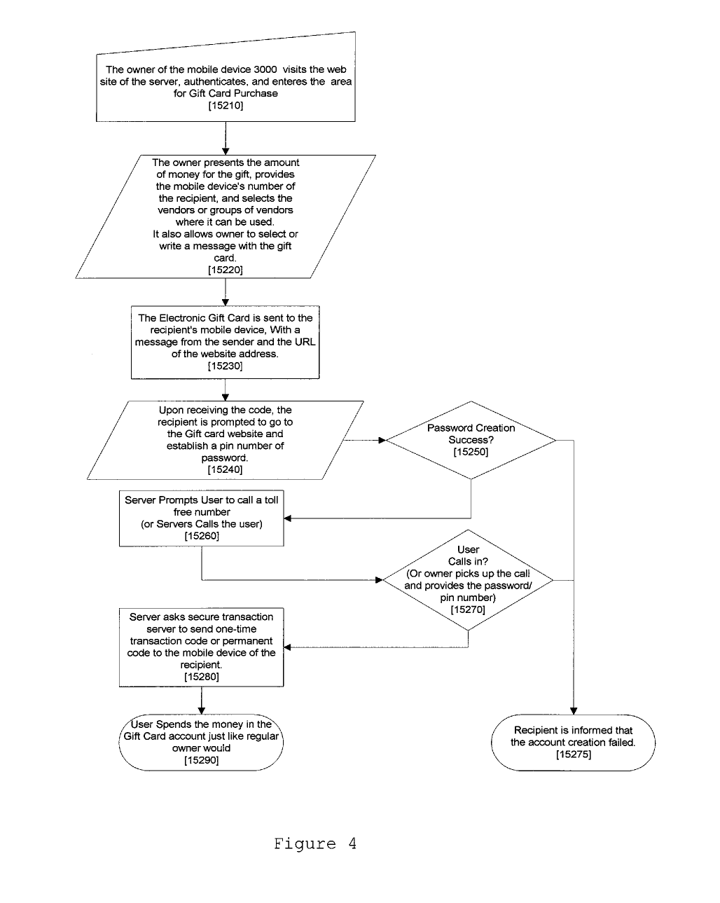

FIG. 4 is diagram of Sending electronic gift card and establishing gift card account.

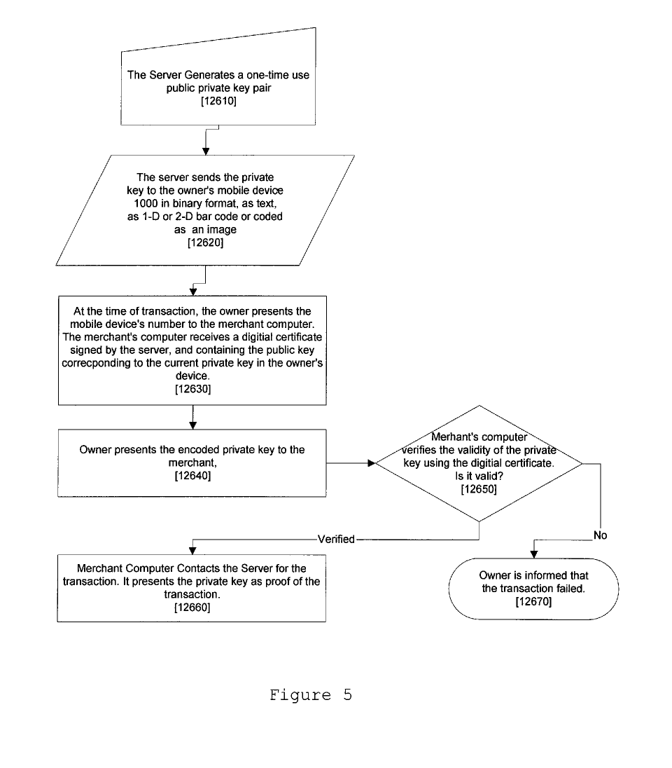

FIG. 5 is diagram of a Public key based transaction.

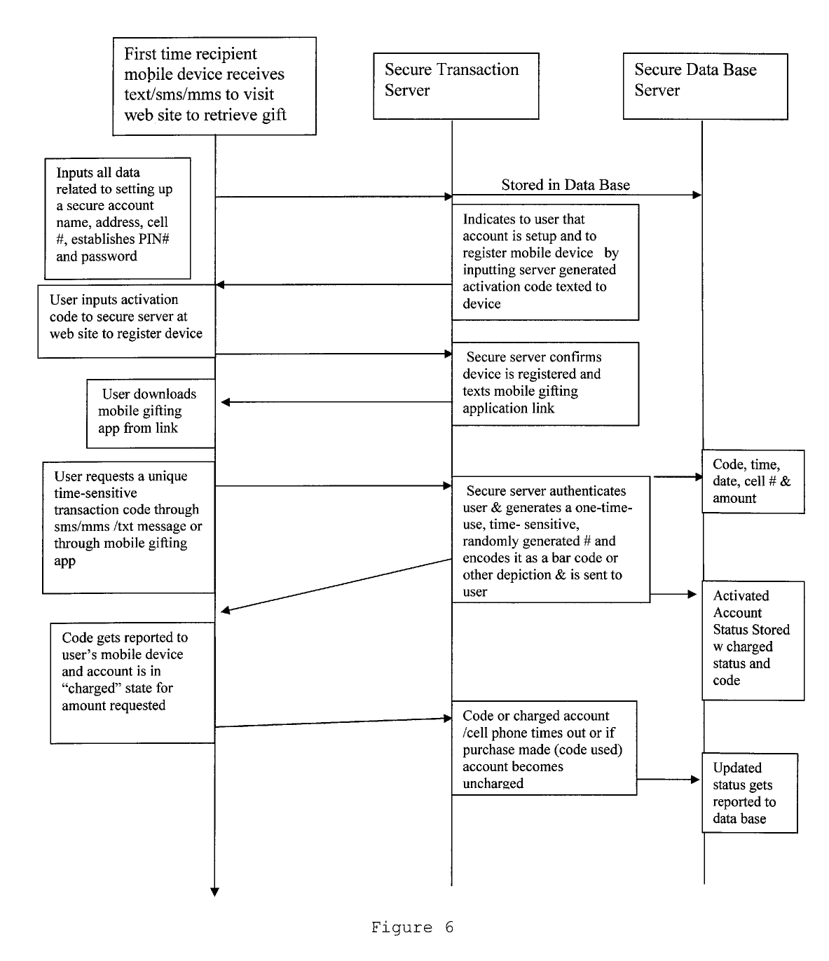

FIG. 6 is diagram of a Activation of Mobile Communication Device (First Time Gift Recipient).

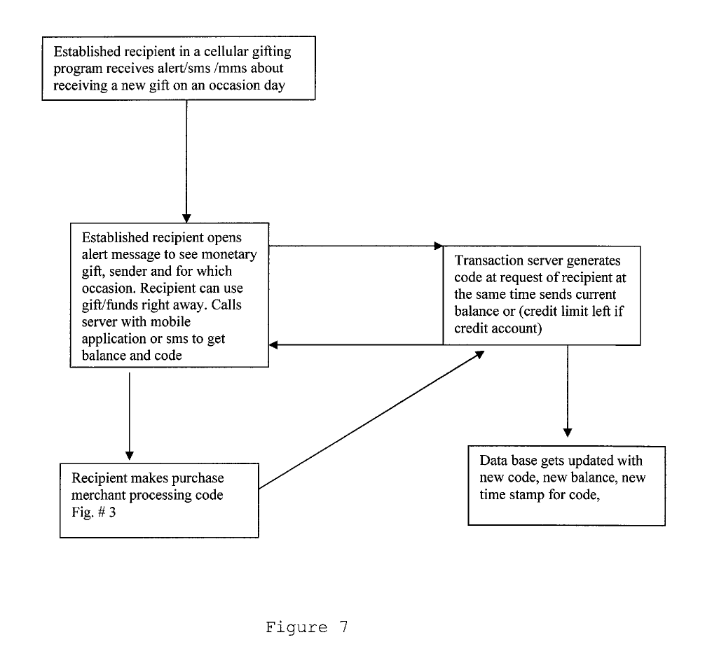

FIG. 7 is a diagram of Established Recipient That Receives Gift.

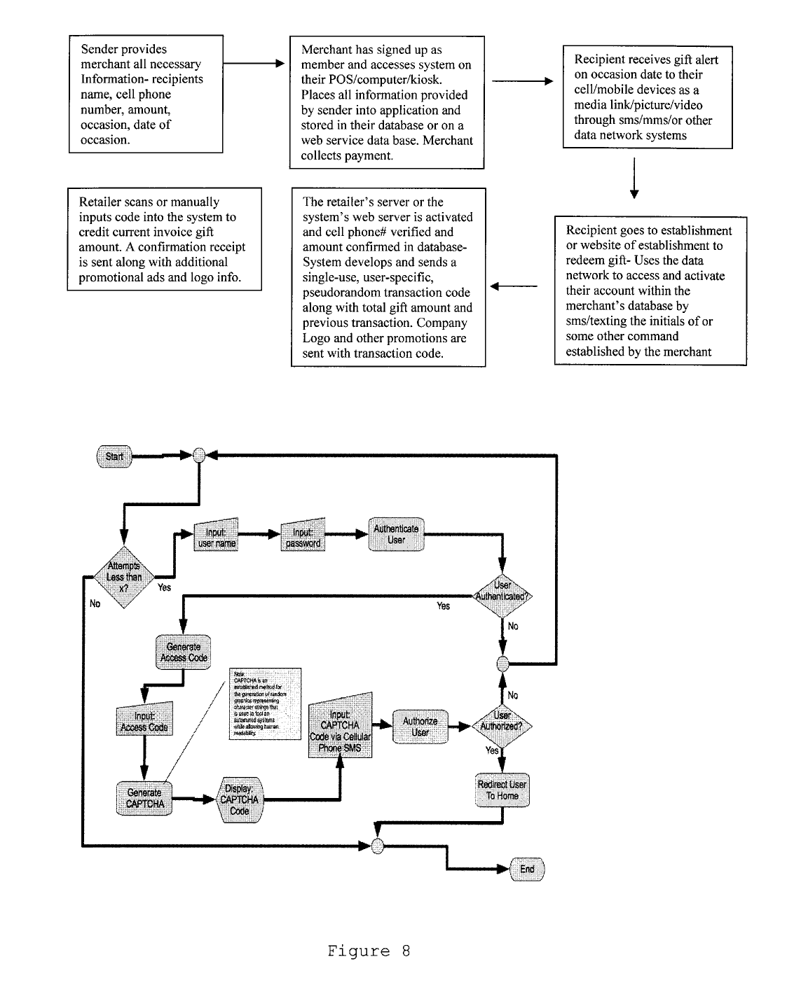

FIG. 8 is diagram of an in-store purchase and redemption of an Electronic Gift Card.

### DETAILED DESCRIPTION OF THE PREFERRED EMBODIMENT

In [12110], the owner of the mobile device accesses the secure web server 12000 using computer running web browser 1000. It is expected that in most cases, the user will have the web browser running on the same mobile device 3000. In [12120] the server prompts the user to enter full name, address, phone number, and other personal information that might be appropriate for establishing a secure account and for the specific business needed to establish identity and verify the credit or financial status of the owner of the mobile electronic device. Alternatively, the user can provide numbers of multiple mobile devices. All these devices will be authorized to spend, but the authorization will only come from the original phone. The server also prompts the user to establish a password, establish a personal identification number (PIN) and provide their digital mobile device cell phone number. The owner is required to register digital mobile device by inputting phone-activation code sent to mobile device via sms or by sever calling device or any other method, into registration web site securely connected to server. [12126] The server successfully verifies both the identity of the owner of the mobile device [12130] and the device itself after inputting the activation code, then the process proceeds. In some embodiments of this innovation, this might involve significant manual research by a human before the server can provide verification. Once the identity is verified, the web server send a application link to the registered devices to allow for the download of mobile gifting application this will all owner to contact the transaction server to send a user and mobile device specific, single-use, time-sensitive, pseudorandom transaction code [12140] to the mobile device 3000. Alternatively, the owner can obtain transaction code via alternative routes (sms, mms, calling server). The transaction server generates this unique user and device specific, time-sensitive, pseudorandom code, which in preferred embodiment is unique to the phone number, the owner and the established secure account but in alternative embodiment, is unique globally within a given time period. The expected number of transactions determines the size of this pseudorandom number. Any time the owner requests and the mobile device receives this unique single-use transaction code, the owner/device is ready to do a transaction. The code can be sent to the device in one of the several formats: 1) simple text transaction code, 2) an image with the code encoded in bar code, 3) an image with 2-D bar code, 4) a uniquely customized image 5) some encrypted variation of text or image that can only be decrypted by the user using a password 6) a temporary private key encoded in a 2-bar code or in a customized image. The code can also be forwarded to another mobile device, when the owner opts to do so. The owner also may choose to share the code with other registered devices by forwarding them the code.

When the owner wants to conduct a transaction, the owner of the mobile device 3000 will access the server and request a transaction code to be sent to the mobile by calling a specific number or text messaging (SMS/MMS) the server or by requesting said code through the mobile gifting application. Once the mobile phone device and user identity is verified then the secure transaction server will generate and send the unique single-use transaction code.

If the credentials provided by the owner in 12120 are not consistent or due to research it is determined that the owner is a financial risk for this type of transactions, the user is informed about the failure of account creation [12160].

In [12210], when the owner wants to conduct a transaction, the owner of the mobile device 3000 presents/shows the unique user and device-specific, time-sensitive single-use transaction code on the mobile device 1000 to the merchant. In the merchant enters, or scans the code into the merchant computer 2000. In alternative embodiment, the mobile device owner enters the code into the merchant's POS computer, web site or into the merchant's mobile gifting application directly by typing or scanning or transmitting using any form of electronic spectrum. The merchant computer 2000 sends the entered code to the transaction server 13000 using a secure connection [12230]. The uniquely generated user and device specific, single-use pseudorandom code is generated for that specific cell phone number/account to be used one time and can only be obtained with the activated registered digital mobile device and the registered PIN that the user created when activating their account. The unique code will also be time and date stamped. If the transaction code is the current code for that given phone number/account (there can be a given amount of outstanding valid transaction code at any given time based on user's preference) the transaction servers approves the transaction by sending an acknowledgement to the merchant [12245], and it also sends a new randomly generated single-use transaction code to mobile device 3000 [12250] automatically or when prompted by the owner.

If there is a problem with the one-time transaction code or the phone number, the transaction server rejects the transaction [12260].

It is possible though unlikely, that the one-time transaction code is lost during the communication process. If that happens, one method of recovery dictates that the owner visits the secure web server 12000 of the service using computer running web browser 1000 [12310]. The owner then enters the username and password to log in [12320]. If the owner has forgotten her username and password, the web site prompts for all information that was entered during creation of account. The server then verifies the identity of the owner [12330]. If the verification is successful, the server sends a new transaction code, and the previous transaction code is cancelled (declared invalid) [12340]. Alternatively, using the mobile gifting application can request to delete active transaction code making this invalid and unusable to the system's transaction server.

In [15210] to send an electronic gift card, a busy owner of the mobile device 3000 can visit the web site of the server 1200 authenticates and enters the area for Gift Card Purchase. Assuming that the owner has enough money in his account, he can present the amount of money that he intends to send in form of the gift card, provides the number of recipient's mobile device, and selects the vendor or groups of vendors where the recipient can use the gift card (optional). It also allows owner to select or write a message with the gift card [15220]. The Electronic Gift Card is sent to the recipient's mobile device, with a message from the sender and the URL of the website address where recipient can enable their “gift card” [15230]. Upon receiving the message, the recipient is prompted to go to the gift card's website so that they can establish a secure account using their cell phone or mobile device's number, at the same time establish a PIN number and password [15240]. If the password and PIN creation is successful the server prompts the recipient, through a sms link to upload the mobile gifting application.

Using the mobile gifting application or sms,mms modalities the user requests the secure transaction server to send single-use transaction code or permanent code to the mobile device of the recipient [15280]. User spends the money in the gift card account just like a regular debit/credit card owner or card holder would [15290]. The sender of the mobile gift card is sent an alert notification that the recipient established their secure account and this verifies to sender that the gift has been received by recipient. If within a certain amount of predetermined time (ex. 48 hrs) multiple alerts (4-5) sent to the recipient, prompting the recipient to establish the secure mobile account have passed and the account has not been established the “gift” will be placed in the sender's personal secure mobile account for their use. If the recipient fails to create a password, does not call in or does not pick up the mobile device, the account creation is failed and the sender of the mobile gift card is notified, [15275] and the “gift” is placed in the sender's account for their use.

In [12610], the server generates a single-use public-private key pair. It then sends the private key to the owner's mobile device 1000 in binary format, as text, as 1-D or 2-D bar code or coded as an image [12620]. To increase the security this private key can be further encrypted by a long-term key established between the transaction server 1300 and the mobile device 1000. At the time of transaction, the owner presents the mobile device's number to the merchant computer. The merchant's server contacts the transaction server and receives a digital certificate signed by the server, and containing the public key that matches with the current private key in the owner's device [12630]. The owner presents the encoded private key to the merchant's computer [12640], and merchant's computer verifies the validity of the private key using the digital certificate [12650]. If merchant's computer verifies that the private key indeed matches the digital certificate it had received, it presents the private key to the server as proof of the transaction [12660]. If the key does not verify, the owner is informed that the transaction has failed [12670].

In an alternative embodiment, a mobile gifting system is disclosed with which a user may send a gift of protected funds to another person or allocate protected funds to themselves as an currency isolation proxy to their other financial accounts and may generate a single-use, one-time user and device specific transaction codes against those funds from the users mobile phone for the purpose of purchasing goods with what is, in essence, a disposable financial account number. The disposable account number, along with other industry standard security features and tracking mechanisms, render all currently known methods of credit card, gift card and cyber theft either impossible, ineffective or generally unattractive.

In this embodiment the following steps take place:

1. Generate Code ID uses the user PIN, date time and phone number and a configurable offset value to create a unique, time use, time sensitive code for purchasing goods or services. User must specify an amount when requesting a Code ID and if unused a Code ID expires after a 3 hour period. A user can only have 5 unused Code IDs open at any given time.

2. Spend Code ID is the merchant interface. Upon receiving values from barcode or from a phone number/Code ID combo it will deduct credits from the users account and deposit currency into the merchants account. So this is in actuality 2 functions.

### Function 1:

Parameters: string from barcode, merchant id, merchant password.
Step 1: Separate Barcode into the fields from which it came.
Step 2: Extract the Code ID, index and date-time strings.
Step 3: Reject transaction if date-time is out of range.
Step 4: Reverse the checksum to get the phone number.
Step 5: Reject if phone number is invalid.
Step 6: Lookup the Code ID using the phone number and index and reject if invalid.
Step 7: Check Code ID value vs. purchase value and return the difference.

### Function 2:

Parameters: Code ID, 10 digit cell number.
Step 1: Extract the Code ID, index and date-time strings.
Step 2: Reject transaction if date-time is out of range.
Step 3: Reject if phone number is invalid.
Step 6: Lookup the Code ID using the phone number and index and reject if invalid.
Step 7: Check Code ID value vs. purchase value and return the difference.
Check user balance will return the users total balance from all gifts minus all debits.

3. Register User—provides interface for adding new users.

4. Register Phone—activates the phone of a user for use with Code ID generation and purchasing.

5. Register Merchant—Provides interface for the adding of a new merchant.

6. Send Gift—Provides interface for the sending of funds and an html gift card to another user.

7. Retrieve gifts—provides interface for getting a collection of gift objects allocated to a certain user.

8. Allocate Gift Fund.

9. Create Gift Card—provides interface for creation of a gift card object. The function returned a gift card ID for use with the send gift function.

10. View Occasions—returns all occasions we have on file.

11. View Media—provides interface for retrieving a collection of media objects.

12. Upload Media—provides interface for adding new media to the system.
A user will open their smartphone with the application.
The user will select the Code ID option User must specify an amount when requesting a Code ID and if unused a Code ID expires after a 3 hour period. A user can only have 5 unused Code IDs open at any given time.
The user will be prompted for a PIN.
If unsuccessful the user will be granted 2 more attempts.
If PIN entered 3 times unsuccessfully, application will close.
If successful the Code ID menu will be displayed. Generation will not invalidate subsequent Code ID operations as long as the user does not have more than the configured threshold already.
If successful the Code ID will be generated and displayed.
User presents Code ID to transaction system via:
Barcode scanner
NFC
Manual entry (short code)
Other mediums can be added as discovered
   Merchant system returns “OK” or “Failure” and transaction completes.

System Point of View.
A user will open their smartphone Code ID application.
The user will select the Code ID option.
The GPS coordinates of the phone will be queried.
The user's SSL private key will be loaded.
The user will be prompted for a PIN.
The PIN will be used to attempt user's Private key decryption.
If unsuccessful the user will be granted 2 more attempts.
If PIN entered x times unsuccessfully, application will post the GPS coordinates to the Code ID app server and then close. The account holder will be sent an email and SMS that their account is disabled and to contact support.
If successful:
The generated Code ID function will be called over TLS with server/client authentication and passed GPS info if available.
The Code ID will be generated on the server and a link returned with the barcode and text representing the Code ID in the fashion previously discussed.
The local app will extract and download the barcode and store it for the allotted time specified by the global Code ID timeout.
The barcode (and the short code) will then be displayed.
Until the Code ID is used or times out, it will be accessible via another UI option “Active Code IDs”.
User presents Code ID to transaction system via:
Barcode scanner
Merchant POS system with this capability decodes and parses the barcode and passes appropriate values to the merchant web service
NFC
User will use a “right-click” style of option to select “send to NFC.
Application will decode barcode in memory and send the barcode information as a character stream to the NFC reader device.
Merchant POS system with this capability decodes and parses the data stream and passes appropriate values to the merchant web service.
Manual entry (short code)
Manual entry will require the user to verbally communicate the short code as well as the phone number to the merchant.
The merchant will manually enter the data into their system which will then call the merchant web services.
Other mediums can be added as discovered.
most other mediums will be carried out in the same fashion as NFC.
Merchant returns success or failure. Transaction completes.

Advanced Authentication Flow.

Dual Channel Authentication Methodology.
User provides username and password to the Code ID enhanced application.
Application calls function for user authentication.
If successful, access code is generated and sent to user (SMS or email). The access code is generated using the Code ID generation algorithm but using phone digits instead of PIN.
User brought to next screen asking for access code.
If user successfully submits access code, they are then directed to their application home view.
If a user is unsuccessful x times for any of the above submissions, their account is locked for a time period determined by an entry in a server configuration file.

In another embodiment, the store may purchase a WirelessGift wherein:
1) The retailer is already established with the Electronic Gift Carding program by having an account and agreeing to the terms or downloads the application to their POS system. The retailer can access their account through the web services.
2) Sender/Player approaches POS/Customer Svc. department or a kiosk to send a recipient-player a WirelessGift from that specific establishment (i.e. Restaurant, Dept. store or Movie Theater, etc.).
3) The retailer accesses the “Send an electronic gift card” page where the information provided by the Sender is filled into the appropriate fields by the employee and is either stored within the establishments database or in the web service's database. Employee collects the payment.
4) The standard information includes:
   1) Sender name and cell number, 2) recipients name and cell number, 3) the type occasion or reason for gift (if any) with memo, 4) the date to be sent, 5) the amount of the Electronic Gift Card and 6) a decorative branding theme preapproved by the establishment and uploaded to their account when sent as a SMS/MMS/Picture/Video message. Other information stored 1) date of purchase, 2) Merchant Info.
5) The above information is stored and queued in the establishment's application and database or the web service's database/system and the alert sent on the date requested. (Note the monies are already collected by the establishment and we charge for installation, monthly maintenance & transaction process).
6) The recipient will receive the Electronic Gift Card via SMS/MMS/Video/media Link with Sender's name, specified amount and a retailer logo.
7) REDEMPTION—The recipient goes to the establishment/franchise where the Electronic Gift Card was purchased. Has instructions posted by establishment on the WirelessGifting advertisement on how to redeem the Electronic Gift Card:
Text the “name or initials” of the establishment (predetermined by retailer) to system's short code (data communication network). The system verifies recipient's cell and status, and a single-use, user-specific, time-sensitive pseudorandom transaction code is sent to the recipient as a text message along with total gift balance remaining. They will provide this to the cashier along with their cell number to approve the redemption.

In this embodiment the Merchant/retailer establishes a web service account and joins the Electronic Gift Carding program by accessing the online web service program or downloading application and database storage
Once merchant/retailer registered, the retailer will access the application or account web services in order to be able to send a electronic gift card on behalf of the sender to their recipient of choice.
Retailer clerk (or Sender-Kiosk) inputs all necessary data which includes the name and cellular phone device # of recipient, name of sender, amount of gift, and date to be sent for specific occasion.

The sender pays for electronic gift card at the time of purchase.
The recipient (owner of the cell phone/communication device) gets alerted of electronic gift card for that specific establishment and amount (on the day that was preselected by the sender) via the cellular network/communication system.
The recipient's cellular data, amounts are stored and redemption dates managed by the gift card (or like) service or the application residing in the establishments system.
Redemption/Use of the gift card service is activated by recipient sending a keyword command or action command to the gift card application service through the cellular/communication network
The electronic gift card service will verify the cellular communication device and the amount and a unique user-specific, pseudorandom, single use redemption code is generated and sent to device using the cellular/communication system along with amount remaining in account.
This uniquely generated pseudorandom, user-specific redemption code and the cellular device phone # is given to the retailer-Retailer accesses their electronic gift card account/application and inputs the code, the phone number.
The code verified within in the system and credit given against amount within account. Receipt and promotional ad sent for next purchase.

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

All patents and publications mentioned in this specification are indicative of the levels of those skilled in the art to which the invention pertains. All patents and publications are herein incorporated by reference to the same extent as if each individual publication was specifically and individually indicated to be incorporated by reference. It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1: A method of creating a proxy gifting account card comprising the step of:
connecting to a gifting account database maintained on a secure web server by use of a first communication device;
forming a registration account on said secure web server for storage of certain information, said registration account secured by use of a personalized identification number,
forwarding an activation code and application link to said first communication device upon successful registration account formation;
verifying said activation code to allow access to said gifting account database has been received by said communication device;
presenting said secure web server with electronic funds to be credited to at least one selected merchant associated with said registration account;
providing said secure web server with a telephone number of a mobile communication device;
forwarding a code to said mobile communication device prompting access to said gifting account database and activating a second account;
verifying said code has been received by said second communication device;
receipt of an application link by said second communication device from said web server, said second communication device verified to allow access to said gifting account database;
wherein the electronic funds are made available to the operator of the mobile communication device for use with a selected merchant.

2. The method according to claim 1 wherein said first communication device is a mobile telephone.

3. The method according to claim 1 wherein said first communication device is a desktop computer.

4. The method according to claim 1 including the step of allowing said communication device to deliver a message to said mobile communication device.

5. The method according to claim 1 wherein said code is a one-time transaction code.

6. The method according to claim 1 wherein said one-time transaction code is a device specific pseudorandom time-sensitive generated transaction code.

7. The method according to claim 1 wherein said code is a permanent transaction code.

8. The method according to claim 6 or 7 wherein said transaction code is embedded in an image.

9. The method according to claim 8 wherein said image is a bar code.

10. The method according to claim 1 wherein said code can be shared with another registered communication device.

11. The method according to claim 1 wherein said code is time and date stamped.

12. The method according to claim 1 wherein said registration account is linked to said secure account by a PIN number and a private/public key encryption through a secure tls/ssl communication channel.

13. The method according to claim 4 wherein said message is in text format.

14. The method according to claim 4 wherein said message is in video format.

15. The method according to claim 1 including the step of authorizing payment to the merchant from electronic funds.

16. The method according to claim 15 including the step of generating a message to the communication device notifying payment made to the merchant.
